(19) United States
(12) Patent Application Publication
(10) Pub. No.: US 2024/0249269 A1
(43) Pub. Date: Jul. 25, 2024

(54) ITEM INFORMATION READING APPARATUS, METHOD, AND STORAGE MEDIUM

(71) Applicant: Toshiba Tec Kabushiki Kaisha, Tokyo (JP)

(72) Inventor: Shigeaki SUZUKI, Gotemba Shizuoka (JP)

(21) Appl. No.: 18/539,151

(22) Filed: Dec. 13, 2023

(30) Foreign Application Priority Data
Jan. 20, 2023 (JP) 2023-007466

(51) Int. Cl. G06Q 20/20; G06F 3/0482; G06K 7/10; G06Q 10/087

(52) U.S. Cl. CPC G06Q 20/208; G06F 3/0482; G06K 7/10297; G06K 7/10544; G06Q 10/087

(57) ABSTRACT

An item information reading apparatus includes an antenna; a scanner; a network interface connectable to an external device; and a processor configured to cause the antenna to wirelessly read code information for uniquely identifying an item from a wireless tag, cause the scanner to read code information for uniquely identifying an item from a code symbol, compare the code information read by the antenna with the code information read by the scanner, and cause the network interface to transmit to the external device one or both of the code information read by the antenna and the code information read by the scanner based on a comparison result of the code information read by the antenna with the code information read by the scanner.

### CROSS-REFERENCE TO RELATED APPLICATION

This application is based upon and claims the benefit of priority from Japanese Patent Application No. 2023-007466, filed Jan. 20, 2023, the entire contents of which are incorporated herein by reference.

### FIELD

Embodiments described herein relate generally to an item information reading apparatus, a method, and a storage medium.

### BACKGROUND

A known item information reading apparatus selectively performs the reading of a wireless tag such as a radio-frequency identification (RFID) tag or the reading of a code symbol such as a barcode or a two-dimensional code.

With such an item information reading apparatus, when both of a barcode and a wireless tag are attached to an item, the operator consciously selects one of the reading of the barcode and the reading of the wireless tag.

### SUMMARY OF THE INVENTION

Embodiments of the present disclosure provide an item information reading apparatus, a method, and a storage medium capable of reading item information without requiring an operator to be aware of whether a barcode or a wireless tag is to be read.

According to an embodiment of the present disclosure, an item information reading apparatus includes an antenna; a scanner; a network interface connectable to an external device, and a processor configured to cause the antenna to wirelessly read code information for uniquely identifying an item from a wireless tag, cause the scanner to read code information for uniquely identifying the item from a code symbol, compare the code information read by the antenna with the code information read by the scanner, and cause the network interface to transmit to the external device one or both of the code information read by the antenna and the code information read by the scanner based on a comparison result of the code information read by the antenna with the code information read by the scanner.

### BRIEF DESCRIPTION OF THE DRAWINGS

FIG. 1 is a perspective view of an external appearance of an item information reading apparatus according to an embodiment.

FIG. 2 is a diagram of a wireless tag and a code symbol attached to an item.

FIG. 3 is a block diagram of a hardware configuration of the item information reading apparatus.

FIG. 4 is a block diagram of a functional configuration of the item information reading apparatus.

FIG. 5 is a flowchart illustrating a process performed by the item information reading apparatus.

FIG. 6 is a block diagram of a functional configuration of an item information reading apparatus according to a modified embodiment.

FIG. 7 is a flowchart illustrating a process performed by the item information reading apparatus.

FIG. 8 is a flowchart illustrating a process performed by the item information reading apparatus.

### DETAILED DESCRIPTION

Hereinafter, embodiments will be described in detail with reference to the drawings. The present invention is not limited to the embodiments described below.

An item information reading apparatus 100 to which the present disclosure is applied will be described with reference to the drawings.

### (Schematic Structure of Item Information Reading Apparatus)

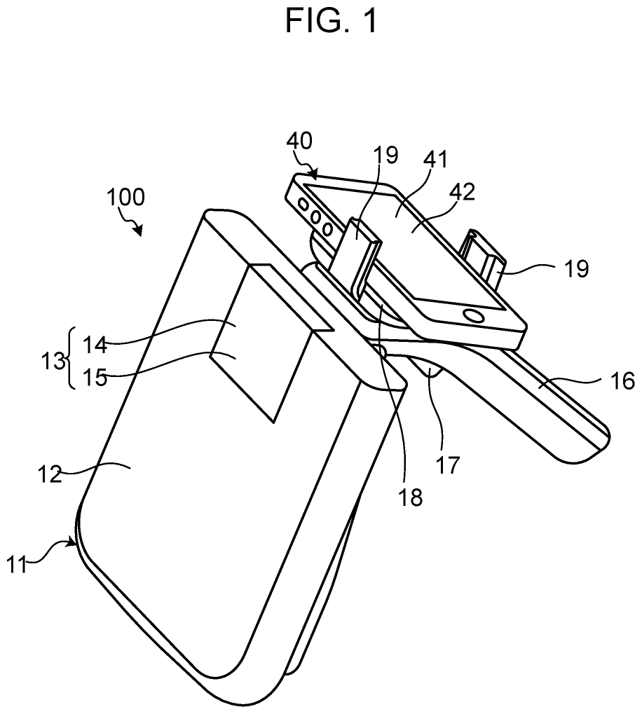

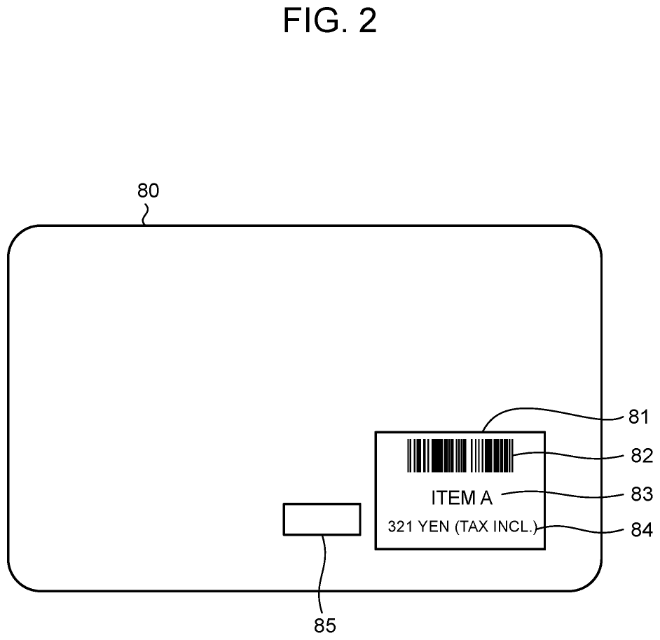

A schematic structure of the item information reading apparatus 100 will be described with reference to FIGS. 1 and 2. FIG. 1 is a perspective view illustrating an external appearance of the item information reading apparatus 100 according to an embodiment. FIG. 2 is a diagram illustrating examples of a wireless tag and a code symbol attached to an item. When an item is to be purchased by a customer, the item information reading apparatus 100 reads item information from a barcode and/or an RFID tag attached to the item. Then, the item information reading apparatus 100 outputs the read item information to an external POS terminal and thereby causes the external POS terminal to register the item and make a payment for the item. Furthermore, the item information reading apparatus 100 reads item information from barcodes and/or RFID tags attached to items when inventorying the items. Then, the item information reading apparatus 100 outputs the read item information to an external server device to generate inventory information of the items.

The item information reading apparatus 100 according to the present embodiment includes an RFID antenna 12, a barcode scanner 13, and a grip 16. The item information reading apparatus 100 is used in a sales floor, a back area, or the like of a store such as a supermarket.

The RFID antenna 12 is enclosed in a housing 11 and reads an Electronic Product Code (EPC) (or an EPC code) stored in a Radio Frequency Identification (RFID) tag 85 (see FIG. 2) by wirelessly communicating with the RFID tag 85. Note that the RFID tag 85 is an example of a wireless tag in the present disclosure.

The barcode scanner 13 is disposed on the front surface of the housing 11 and reads an item code such as a Japanese Article Number (JAN) code represented by the barcode 82 (see FIG. 2). The barcode 82 is an example of a code symbol in the present disclosure. The barcode scanner 13 includes a camera 14 and a light emitting diode (LED) 15. The camera 14 captures an image of the barcode 82. The LED 15 emits a slit-shaped light beam onto an imaging area of the camera 14. The operator of the item information reading apparatus 100 moves and positions the item information reading apparatus 100 so that the slit-shaped light beam emitted by the LED 15 crosses the barcode 82, and causes the item information reading apparatus 100 to read the barcode 82.

The grip 16 is connected to an upper portion of the housing 11 and has a curved shape. The operator holds the grip 16 with one hand when using the item information reading apparatus 100.

A trigger switch 17 is disposed at the base of the grip 16. The trigger switch 17 causes the RFID antenna 12 to start reading the RFID tag 85 and causes the barcode scanner 13 to start reading the barcode 82. More specifically, when the operator of the item information reading apparatus 100 presses (or squeezes) the trigger switch 17, the reading by the RFID tag 85 and the barcode 82 is started.

A pedestal 18, on which a portable terminal 40 is placeable, is disposed on an upper portion of the grip 16. The portable terminal 40 placed on the pedestal 18 is sandwiched between a pair of clamping parts 19 and is thereby fixed to the item information reading apparatus 100.

The portable terminal 40 includes a display device 41 and an operating device 42. The portable terminal 40 is connected to the item information reading apparatus 100 by wireless communication and displays code information read by the item information reading apparatus 100 on the display device 41. Also, detailed operation instructions are given to the item information reading apparatus 100 via the operating device 42. The display device 41 is, for example, a liquid crystal monitor or an organic electroluminescence (EL) monitor. The operating device 42 is, for example, a touch panel stacked on the display device 41. The portable terminal 40 is, for example, a smartphone. Note that the item information reading apparatus 100 may include the display device 41 and the operating device 42.

As illustrated in FIG. 2, an item label 81 is attached to a surface of an item 80 to be read by the item information reading apparatus 100. A barcode 82, an item name 83, and a price 84 are printed on the item label 81. The barcode 82 represents a JAN code or the like for uniquely identifying the item 80.

An RFID tag 85 is attached to the item 80. The RFID tag 85 stores an EPC code for uniquely identifying the item 80. The EPC code includes a JAN code and other information, such as a serial number of the item 80.

FIG. 2 is provided as an example, and the RFID tag 85 maybe integrated with the item label 81 on which the barcode 82 is printed.

### (Hardware Configuration of Item Information Reading Apparatus)

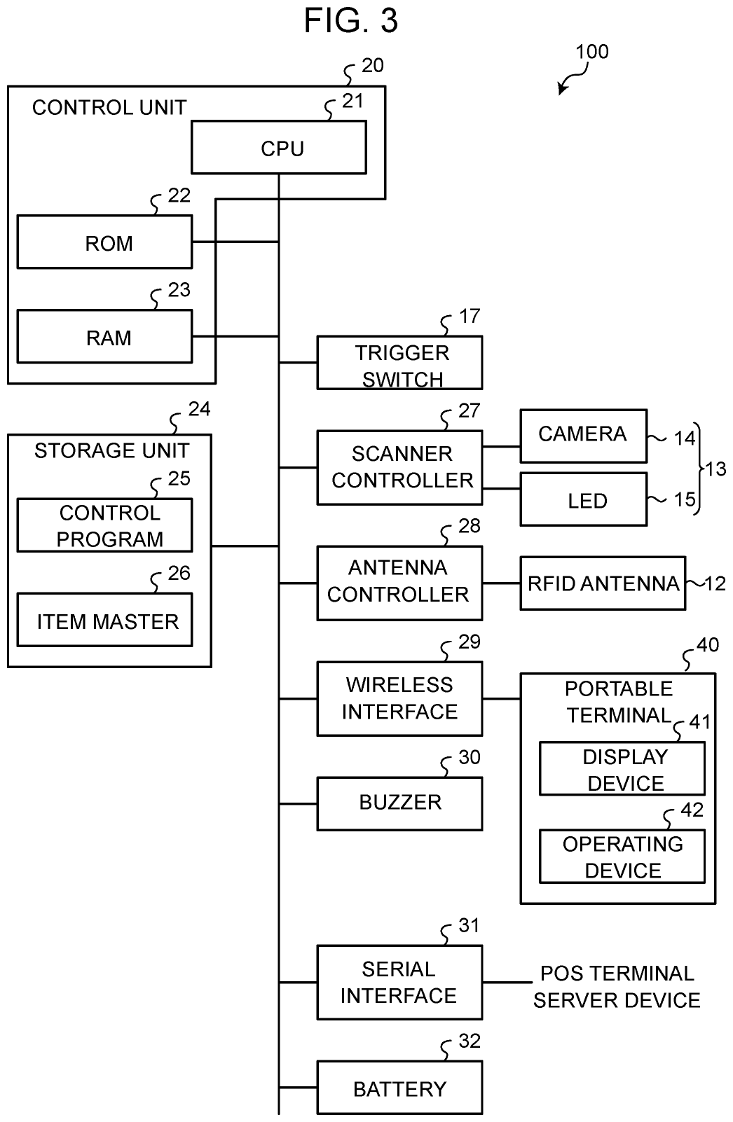

A hardware configuration of the item information reading apparatus 100 will be described with reference to FIG. 3. FIG. 3 is a block diagram of a hardware configuration of the item information reading apparatus 100 according to the embodiment.

The item information reading apparatus 100 has a configuration in which a control unit 20, a storage unit 24, and various peripheral devices are connected to each other via an internal bus.

The control unit 20 includes a Central Processing Unit (CPU) 21, a Read-Only Memory (ROM) 22, and a Random Access Memory (RAM) 23.

The CPU 21 controls the entire operation of the item information reading apparatus 100. The ROM 22 stores various programs and various types of data for operating the CPU 21. The RAM 23 is used as a work area of the CPU 21, and the programs and the data stored in the ROM 22 and the storage unit 24 are loaded into the RAM 23. The control unit 20 performs various control processes of the item information reading apparatus 100 by loading the programs stored in the ROM 22 and the storage unit 24 into the RAM 23 and thereby operating the CPU 21.

The storage unit 24 stores a control program 25 and an item master 26.

The control program 25 is a program for operating the item information reading apparatus 100.

The control program 25 executed by the item information reading apparatus 100 of the present embodiment may be provided on a computer-readable recording medium such as a CD-ROM. Also, the control program 25 maybe stored in a computer connected to a network such as the Internet and downloaded via the network. Furthermore, the control program 25 maybe provided or distributed via a network such as the Internet.

The item master 26 is a master file that stores information related to items sold at a store. The item information reading apparatus 100 compares information read from the barcode 82 or the RFID tag 85 with the information in the item master 26 to confirm the read information. Note that the item master 26 may be stored in an external server device connected to the item information reading apparatus 100. In this case, the item information reading apparatus 100 communicates with the server device to confirm the read information.

The item information reading apparatus 100 is connected to peripheral devices such as a trigger switch 17, a scanner controller 27, an antenna controller 28, a wireless interface 29, a buzzer 30, a serial interface 31, and a battery 32.

As described above, the trigger switch 17 is a switch for instructing the start of the reading of the RFID tag 85 by the RFID antenna 12 and the start of the reading of the barcode 82 by the barcode scanner 13.

The scanner controller 27 controls the operation of the barcode scanner 13 based on an instruction from the control unit 20. A camera 14 and an LED 15 are connected to the scanner controller 27.

The antenna controller 28 controls a radio wave transmitting operation and a radio wave receiving operation performed by the RFID antenna 12 based on instructions from the control unit 20.

The wireless interface 29 is a network interface circuit for connecting the item information reading apparatus 100 to the portable terminal 40. As the wireless interface 29, for example, a Bluetooth (registered trademark) interface is used.

The buzzer 30 notifies that the RFID tag 85 has been newly read based on an instruction from the control unit 20. Since the RFID antenna 12 can read information from a plurality of RFID tags 85 at a time, the operator of the item information reading apparatus 100 recognizes that the reading has been completed when the buzzer 30 stops producing a sound.

The serial interface 31 is an interface that connects the item information reading apparatus 100 to an external POS terminal or an external server device. As the serial interface 31, for example, a universal serial bus (USB) interface is used.

The battery 32 is a secondary battery such as a lithium-ion battery that supplies electric power to the item information reading apparatus 100.

### (Functional Configuration of Item Information Reading Apparatus)

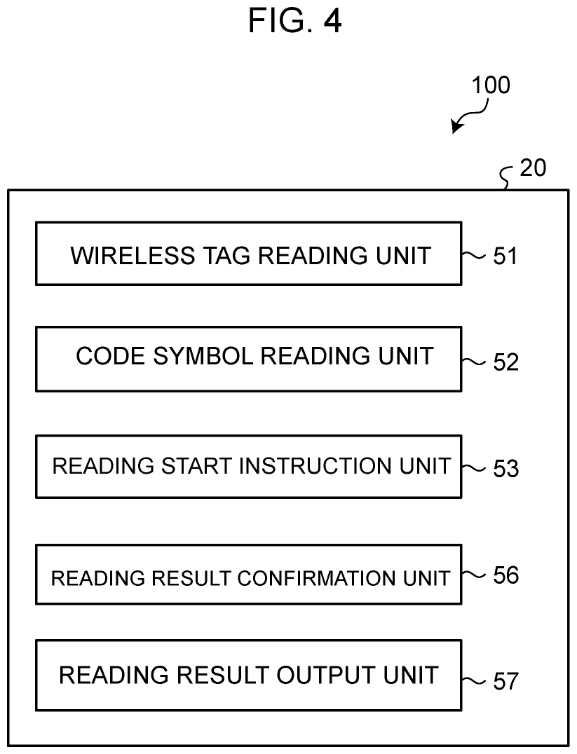

A functional configuration of the item information reading apparatus 100 will be described with reference to FIG. 4. FIG. 4 is a block diagram of a functional configuration of the item information reading apparatus 100 according to the embodiment.

The control unit 20 of the item information reading apparatus 100 loads the control program 25 into the RAM 23 and executes the control program 25 to implement a wireless tag reading unit 51, a code symbol reading unit 52, a reading start instruction unit 53, a reading result confirmation unit 56, and a reading result output unit 57 illustrated in FIG. 4 as functional units. Some or all of these functional units may be realized by dedicated hardware.

The wireless tag reading unit 51 reads code information from the RFID tag 85 (or a wireless tag) that stores the code information for uniquely identifying an item. More specifically, the wireless tag reading unit 51 causes the RFID antenna 12 to read code information from the RFID tag 85. The wireless tag reading unit 51 is an example of a first reading unit in the present disclosure.

The code symbol reading unit 52 reads code information from the barcode 82 (or a code symbol) that represents the code information for uniquely identifying an item. More specifically, the code symbol reading unit 52 causes the barcode scanner 13 to read code information from the barcode 82. The code symbol reading unit 52 is an example of a second reading unit in the present disclosure.

The reading start instruction unit 53 instructs the wireless tag reading unit 51 and the code symbol reading unit 52 to start reading code information. Specifically, the reading start instruction unit 53 instructs the wireless tag reading unit 51 and the code symbol reading unit 52 to start reading code information upon detecting that the trigger switch 17 is squeezed (or pressed).

The reading result confirmation unit 56 confirms a reading result of the code information by comparing the code information read by the wireless tag reading unit 51 with the code information read by the code symbol reading unit 52. The reading result confirmation unit 56 is an example of a determining unit in the present disclosure.

The reading result output unit 57 outputs the reading result of the code information confirmed by the reading result confirmation unit 56 to the portable terminal 40. Also, the reading result output unit 57 outputs the reading result of the code information confirmed by the reading result confirmation unit 56 to the POS terminal or the server device connected to the item information reading apparatus 100.

### (Process Performed by Item Information Reading Apparatus)

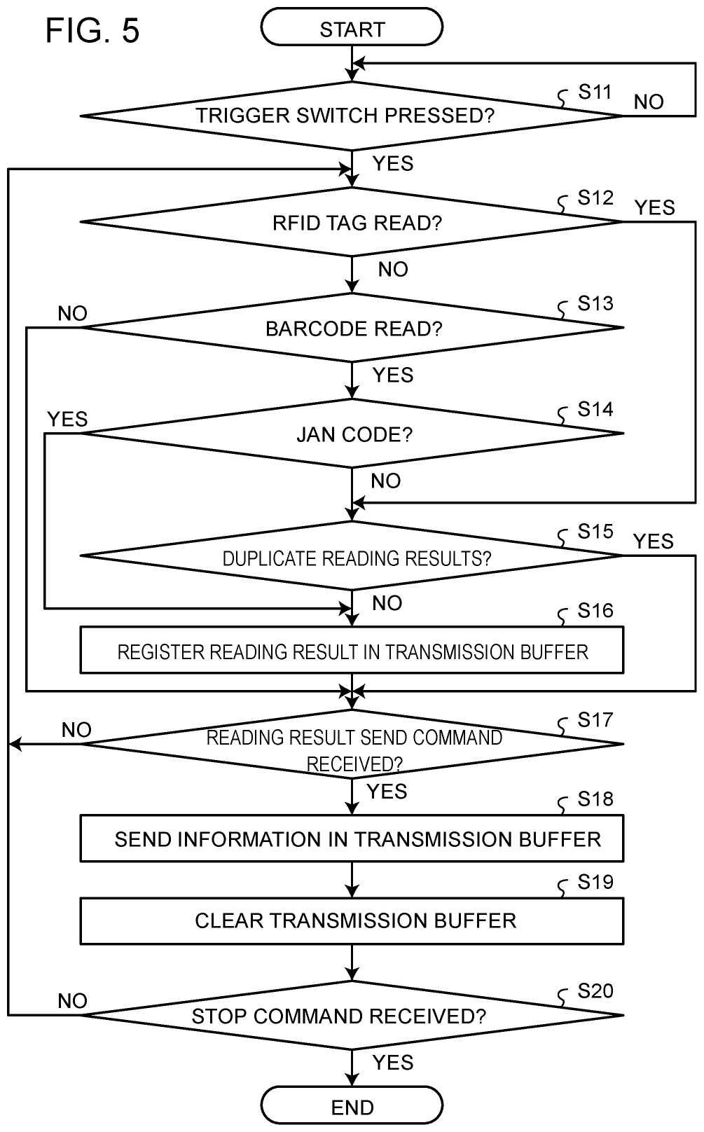

A process performed by the item information reading apparatus 100 will be described with reference to FIG. 5. FIG. 5 is a flowchart illustrating an example of a process performed by the item information reading apparatus 100 according to the embodiment. In this example, it is assumed that the item information reading apparatus 100 reads a JAN code from the RFID tag 85 and/or the barcode 82.

The reading start instruction unit 53 determines whether the trigger switch 17 has been pressed (or squeezed) (step S11). When it is determined that the trigger switch 17 has been pressed (step S11: Yes), the process proceeds to step S12.

On the other hand, when it is not determined that the trigger switch 17 has been pressed (step S11: No), step S11 is repeated.

When it is determined at step S11 that the trigger switch 17 has been pressed, the wireless tag reading unit 51 determines whether the RFID tag 85 has been read (step S12). When it is determined that RFID tag 85 has been read (step S12: Yes), the process proceeds to step S15. On the other hand, when it is not determined that the RFID tag 85 has been read (step S12: No), the process proceeds to step S13.

At step S12, when it is not determined that the RFID tag 85 has been read, the code symbol reading unit 52 determines whether the barcode 82 has been read (step S13). When it is determined that the barcode 82 has been read (step S13: Yes), the process proceeds to step S14. On the other hand, when it is not determined that the barcode 82 has been read (step S13: No), the process proceeds to step S17.

When it is determined at step S13 that the barcode 82 has been read, the code symbol reading unit 52 determines whether the read information is a JAN code (step S14). When it is determined that the read information is a JAN code (step S14: Yes), the process proceeds to step S16. On the other hand, when it is not determined that the read information is a JAN code (step S14: No), the process proceeds to step S15.

When it is determined at step S14 that the read information is not a JAN code, the reading result confirmation unit 56 determines whether the reading result of the wireless tag reading unit 51 and the reading result of the code symbol reading unit 52 are duplicates (step S15). That the reading results are duplicates indicates that the wireless tag reading unit 51 and the code symbol reading unit 52 have read exactly the same information. When it is determined that the reading results are duplicates (step S15: Yes), the process proceeds to step S17. On the other hand, when it is not determined that the reading results are duplicates (step S15: No), the process proceeds to step S16.

When it is not determined at step S15 that the reading results are duplicates or when it is determined at step S14 that the information read from the barcode 82 is a JAN code, the reading result output unit 57 registers the reading result in a transmission buffer (step S16). The transmission buffer is a buffer in which the reading result output unit 57 temporarily stores information to be output to the POS terminal or the server device connected to the item information reading apparatus 100.

When it is not determined at step S13 that the barcode 82 has been read, when it is determined at step S15 that the reading results are duplicates, or after step S16, the reading result output unit 57 determines whether a reading result send command has been received from the POS terminal or the server device (step S17). When it is determined that the reading result send command has been received (step S17: Yes), the process proceeds to step S18. On the other hand, when it is not determined that the reading result send command has been received (step S17: No), the process returns to step S12. When it is determined at step S15 that the reading results are duplicates, step S16 is skipped, and the process proceeds to step S17. This makes it possible to prevent information identical to the JAN code already registered in the transmission buffer from being doubly registered in the transmission buffer at step S16. This in turn makes it possible to reduce the amount of data to be transmitted to the POS terminal or the server device.

When it is determined at step S17 that the reading result send command has been received, the reading result output unit 57 transmits the information registered in the transmission buffer to the POS terminal or the server device (step S18).

Subsequently, the reading result output unit 57 clears the transmission buffer (step S19).

Next, the reading result output unit 57 determines whether a stop command to stop the reading of item information has been received from the POS terminal or the server device (step S20). When it is determined that the stop command has been received (step S20: Yes), the item information reading apparatus 100 ends the process of FIG. 5. On the other hand, when it is not determined that the stop command has been received (step S20: No), the process returns to step S12, and the above-described process is repeated.

The item information reading apparatus 100 may further include a reading information specification unit that specifies a format of information to be read by the code symbol reading unit 52 (second reading unit). Specifically, the reading information specification unit causes the display device 41 of the portable terminal 40 to display a list of selectable information formats (for example, a JAN code, a Code 128, a QR code (registered trademark), and the like). Then, an information format selected by operating the operating device 42 is set as a reading target. FIG. 5 illustrates an example of a process performed when a JAN code is set as the reading target of the code symbol reading unit 52 by the reading information specification unit. Also, the reading information specification unit may specify information without any specific format as a reading target. Furthermore, the reading information specification unit may specify a format (the number of digits, the value of a specific digit, and the like) of information to be read. The reading information specification unit is an example of a specification unit in the present disclosure.

### (Effects of Embodiment)

As described above, the item information reading apparatus 100 of the present embodiment includes the wireless tag reading unit 51 (or a first reading unit) that reads code information from the RFID tag 85 (or a wireless tag) that stores the code information for uniquely identifying an item, the code symbol reading unit 52 (or a second reading unit) that reads code information from the barcode 82 (or a code symbol) that represents the code information for uniquely identifying the item, the reading start instruction unit 53 that instructs the wireless tag reading unit 51 to start reading the code information and instructs the code symbol reading unit 52 to start reading the code information, and the reading result confirmation unit 56 (or a confirmation unit) that confirms a code information reading result by comparing the code information read by the wireless tag reading unit 51 with the code information read by the code symbol reading unit 52. This configuration makes it possible to read item information without requiring the operator to be aware of whether the barcode or the wireless tag is to be read.

The item information reading apparatus 100 of the present embodiment further includes a specification unit that specifies a format of information to be read by the code symbol reading unit 52 (or a second reading unit). This makes it possible to reliably read information with a predetermined format from the barcode 82 (or a code symbol).

### (Variation of Embodiment)

An item information reading apparatus 101 according to a variation of the embodiment will be described. The item information reading apparatus 101 can set a reading start timing separately for each of the barcode 82 and the RFID tag 85.

### (Functional Configuration of Item Information Reading Apparatus)

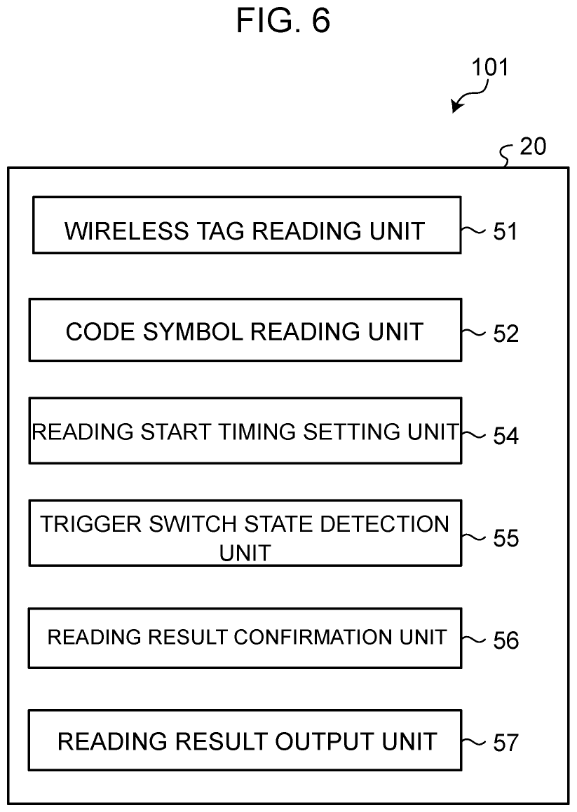

A functional configuration of the item information reading apparatus 101 will be described with reference to FIG. 6. FIG. 6 is a block diagram illustrating an example of a functional configuration of the item information reading apparatus 101 according to a variation of the embodiment.

The item information reading apparatus 101 has the same hardware configuration as the item information reading apparatus 100 described above. The control unit 20 of the item information reading apparatus 101 loads the control program 25 into the RAM 23 and executes the control program 25 to implement functional units including a wireless tag reading unit 51, a code symbol reading unit 52, a reading start timing setting unit 54, a trigger switch state detection unit 55, a reading result confirmation unit 56, and a reading result output unit 57 shown in FIG. 6. Note that some or all of these functional units may be implemented by dedicated hardware.

The functions of the wireless tag reading unit 51, the code symbol reading unit 52, the reading result confirmation unit 56, and the reading result output unit 57 are the same as those of the above-described item information reading apparatus 100, and descriptions of these units are omitted here.

The reading start timing setting unit 54 sets the reading start timing of the wireless tag reading unit 51 (or a first reading unit) (in other words, the reading start timing of the RFID antenna 12) and the reading start timing of the code symbol reading unit 52 (or a second reading unit) (in other words, the reading start timing of the barcode scanner 13). Specifically, the reading start timing setting unit 54 causes the display device 41 of the portable terminal 40 to display a menu for selecting one of an option in which the reading of the barcode 82 (or a code symbol) is started when the trigger switch 17 is pressed while the RFID tag 85 (or a wireless tag) is being read and an option in which the reading of the RFID tag 85 is started when the trigger switch 17 is pressed while the barcode 82 is being read. Also, the reading start timing setting unit 54 sets the reading start timing of the wireless tag reading unit 51 and the reading start timing of the code symbol reading unit 52 based on one of the options selected from the menu by the operating device 42. That is, the reading start timing setting unit 54 controls the barcode scanner 13 and the RFID antenna based on the selected one of the options. The reading start timing setting unit 54 is an example of a setting unit in the present disclosure.

The reading start timing setting unit 54 makes such a setting that the barcode 82 is also read while the RFID tag 85 is being read when the trigger switch 17 is pressed during the reading of the RFID tag 85 to start the reading of the barcode 82. Also, the reading start timing setting unit 54 makes such a setting that the RFID tag 85 is also read while the barcode 82 is being read when the trigger switch 17 is pressed during the reading of the barcode 82 to start the reading of the RFID tag 85. When there are multiple items to be read, the above settings make it possible, for example, to read the RFID tag 85 of one item while reading the barcode 82 of another item and thereby make it possible to reduce the reading time.

Also, the reading start timing setting unit 54 maymake such a setting that when the trigger switch 17 is pressed during the reading of the RFID tag 85, the reading of the RFID tag 85 is stopped and only the barcode 82 is read while the trigger switch 17 is being pressed. Furthermore, the reading start timing setting unit 54 may make such a setting that when the trigger switch 17 is pressed during the reading of the barcode 82, the reading of the barcode 82 is stopped and only the RFID tag 85 is read while the trigger switch 17 is being pressed. When the number of items to be read is small, the above settings make it possible to reliably read the barcode 82 or the RFID tag 85 of each item.

The trigger switch state detection unit 55 detects whether the trigger switch 17 is being squeezed (or pressed).

For example, when only barcodes 82 are attached to some of items or when some of RFID tags 85 are faulty, the reading start timing setting unit 54 makes such a setting that only the barcode 82 is read by default, and the RFID tag 85 is also read while the trigger switch 17 is being pressed,. As another example, when only RFID tags 85 are attached to some of items or when some of barcodes 82 are dirty, the reading start timing setting unit 54 makes such a setting that only the RFID tag 85 is read by default, and the barcode 82 is also read while the trigger switch 17 is being pressed.

Note that the reading start timing setting unit 54 mayalso be configured to be able to select a setting for simultaneously reading the barcode 82 and the RFID tag 85 as in the above-described item information reading apparatus 100.

### (Processes Performed by Item Information Reading Apparatus)

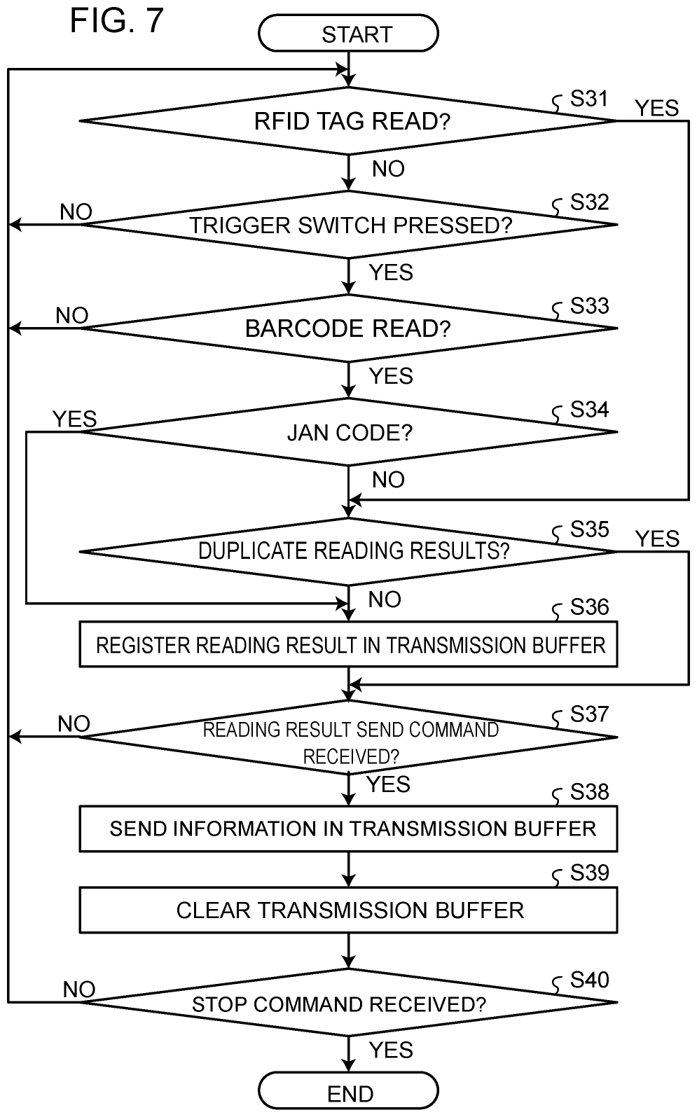

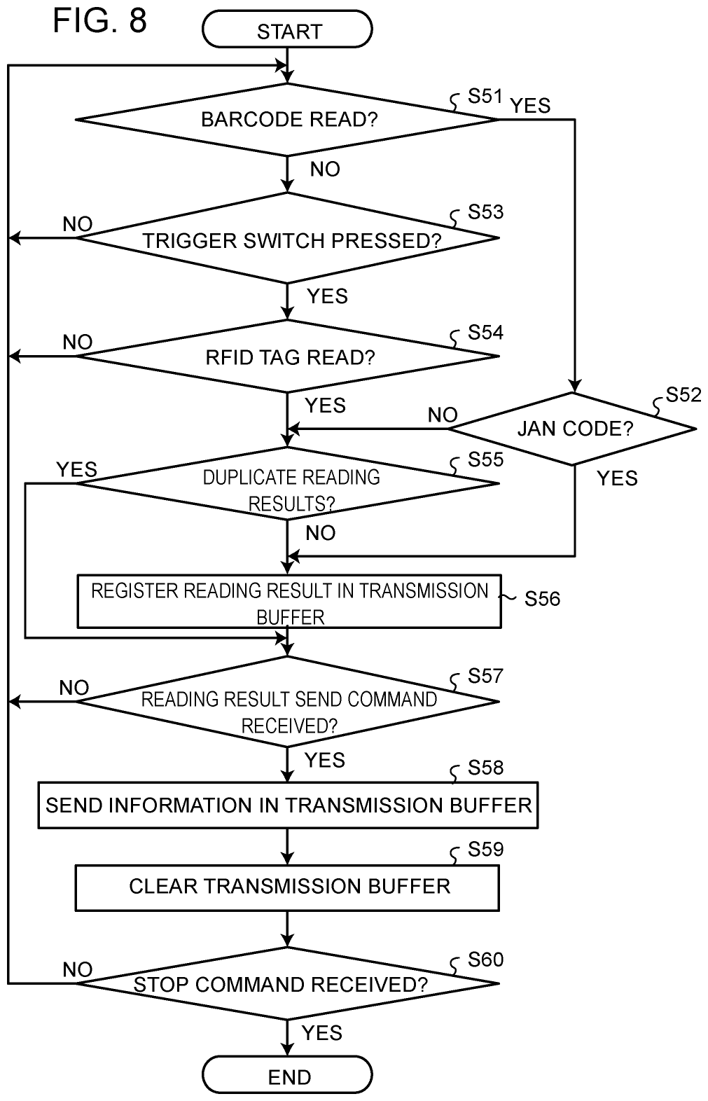

Examples of processes performed by the item information reading apparatus 101 according to a variation of the embodiment will be described with reference to FIG. 7 and FIG. 8. FIG. 7 is a flowchart illustrating a process performed by the item information reading apparatus 101 according to the variation of the embodiment; and FIG. 8 is a flowchart illustrating another process performed by the item information reading apparatus 101 according to the variation of the embodiment.

First, an example of a process performed by the item information reading apparatus 101 will be described with reference to FIG. 7. Note that the flowchart of FIG. 7 shows a process performed by the item information reading apparatus 101 when the reading start timing setting unit 54 has made a setting such that the reading of the barcode 82 is also performed when it is detected that the trigger switch 17 is pressed during the reading of the RFID tag 85.

The wireless tag reading unit 51 determines whether the RFID tag 85 has been read (step S31). When it is determined that the RFID tag 85 has been read (step S31: Yes), the process proceeds to step S35. On the other hand, when it is not determined that the RFID tag 85 has been read (step S31: No), the process proceeds to step S32.

When it is not determined at step S31 that the RFID tag 85 has been read, the trigger switch state detection unit 55 determines whether the trigger switch 17 is being pressed (or squeezed) (step S32). When it is determined that the trigger switch 17 is being pressed (step S32: Yes), the process proceeds to step S33. On the other hand, when it is not determined that the trigger switch 17 is being pressed (step S32: No), the process returns to step S31.

When it is determined at step S32 that the trigger switch 17 is being pressed, the code symbol reading unit 52 determines whether the barcode 82 has been read (step S33). When it is determined that the barcode 82 has been read (step S33: Yes), the process proceeds to step S34. On the other hand, when it is not determined that the barcode 82 has been read (step S33: No), the process returns to step S31.

When it is determined at step S33 that the barcode 82 has been read, the code symbol reading unit 52 determines whether the read information is a JAN code (step S34). When it is determined that the read information is a JAN code (step S34: Yes), the process proceeds to step S36. On the other hand, when it is not determined that the read information is a JAN code (step S34: No), the process proceeds to step S35.

When it is determined at step S34 that the read information is not a JAN code, the reading result confirmation unit 56 determines whether the reading result of the wireless tag reading unit 51 and the reading result of the code symbol reading unit 52 are duplicates (step S35). When it is determined that the reading results are duplicates (step S35: Yes), the process proceeds to step S37. On the other hand, when it is not determined that the reading results are duplicates (step S35: No), that is, when it is determined that the reading results are not duplicates, the process proceeds to step S36.

When it is determined at step S35 that the reading results are not duplicates or when it is determined at step S34 that the read information is a JAN code, the reading result output unit 57 registers the reading result in the transmission buffer (step S36).

Following step S36 or when it is determined that the reading results are duplicates at step S35, the reading result output unit 57 determines whether a reading result send command has been received from the POS terminal or the server device (step S37). When it is determined that the reading result send command has been received (step S37: Yes), the process proceeds to step S38. On the other hand, when it is not determined that the reading result send command has been received (step S37: No), the process returns to step S31.

When it is determined at step S37 that the reading result send command has been received, the reading result output unit 57 transmits the information registered in the transmission buffer to the POS terminal or the server device (step S38).

Subsequently, the reading result output unit 57 clears the transmission buffer (step S39).

Next, the reading result output unit 57 determines whether a stop command to stop the reading of item information has been received from the POS terminal or the server device (step S40). When it is determined that the stop command has been received (step S40: Yes), the item information reading apparatus 101 ends the process of FIG. 7. On the other hand, when it is not determined that the stop command has been received (step S40: No), the process returns to step S31, and the above- described process is repeated.

Next, another example of a process performed by the item information reading apparatus 101 will be described with reference to FIG. 8. The flowchart of FIG. 8 shows a process performed by the item information reading apparatus 101 when the reading start timing setting unit 54 has made a setting such that the reading of the RFID tag 85 is also performed when it is detected that the trigger switch 17 is pressed during the reading of the barcode 82.

The code symbol reading unit 52 determines whether the barcode 82 has been read (step S51). When it is determined that the barcode 82 has been read (step S51: Yes), the process proceeds to step S52. On the other hand, when it is not determined that the barcode 82 has been read (step S51: No), the process proceeds to step S53.

When it is not determined at step S51 that the barcode 82 has been read, the trigger switch state detection unit 55 determines whether the trigger switch 17 is being pressed (or squeezed) (step S53). When it is determined that the trigger switch 17 is being pressed (step S53: Yes), the process proceeds to step S54. On the other hand, when it is not determined that the trigger switch 17 is being pressed (step S53: No), the process returns to step S51.

When it is determined at step S53 that the trigger switch 17 is being pressed, the wireless tag reading unit 51 determines whether the RFID tag 85 has been read (step S54). When it is determined that the RFID tag 85 has been read (step S54: Yes), the process proceeds to step S55. On the other hand, when it is not determined that the RFID tag 85 has been read (step S54: No), the process returns to step S51.

Returning to step S51, when it is determined at step S51 that the barcode 82 has been read, the code symbol reading unit 52 determines whether the read information is a JAN code (step S52). When it is determined that the read information is a JAN code (step S52: Yes), the process proceeds to step S56. On the other hand, when it is not determined that the read information is a JAN code (step S52: No), the process proceeds to step S55.

When it is determined at step S54 that the RFID tag 85 has been read or when it is determined at step S52 that the read information is not a JAN code, the reading result confirmation unit 56 determines whether the reading result of the wireless tag reading unit 51 and the reading result of the code symbol reading unit 52 are duplicates (step S55). When it is determined that the reading results are duplicates (step S55: Yes), the process proceeds to step S57. On the other hand, when it is not determined that the reading results are duplicates (step S55: No), that is, when it is determined that the reading results are not duplicates, the process proceeds to step S56.

When it is determined at step S55 that the reading results are not duplicates or when it is determined at step S52 that the read information is a JAN code, the reading result output unit 57 registers the reading result in the transmission buffer (step S56).

Following the step S56 or when it is determined that the reading results are duplicates at step S55, the reading result output unit 57 determines whether a reading result send command has been received from the POS terminal or the server device (step S57). When it is determined that the reading result send command has been received (step S57: Yes), the process proceeds to step S58. On the other hand, when it is not determined that the reading result send command has been received (step S57: No), the process returns to step S51.

When it is determined at step S57 that the reading result send command has been received, the reading result output unit 57 transmits the information registered in the transmission buffer to the POS terminal or the server device (step S58).

Subsequently, the reading result output unit 57 clears the transmission buffer (step S59).

Next, the reading result output unit 57 determines whether a stop command to stop the reading of item information has been received from the POS terminal or the server device (step S60). When it is determined that the stop command has been received (step S60: Yes), the item information reading apparatus 101 ends the process of FIG. 8. On the other hand, when it is not determined that the stop command has been received (step S60: No), the process returns to step S51, and the above- described process is repeated.

### (Effects of Embodiment)

As described above, the item information reading apparatus 101 of the present embodiment further includes the reading start timing setting unit 54 (setting unit) that sets the reading start timing of the wireless tag reading unit 51 (or a first reading unit) and the reading start timing of the code symbol reading unit 52 (or a second reading unit). This configuration makes it possible to easily select a reading method according to the states of wireless tags and code symbols to be read.

Furthermore, in the item information reading apparatus 101 of the present embodiment, the reading start timing setting unit 54 (or a setting unit) sets whether the reading by the code symbol reading unit 52 (or a second reading unit) is continued or stopped (in other words, whether to cause the barcode scanner 13 to continue or stop reading code information) when the reading by the wireless tag reading unit 51 (or a first reading unit) is started or whether the reading by the wireless tag reading unit 51 is continued or stopped (in other words, whether to cause the RFID antenna 12 to continue or stop reading code information) when the reading by the code symbol reading unit 52 is started. This configuration makes it possible to easily select a reading state according to the states of wireless tags and code symbols to be read.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An item information reading apparatus comprising:
an antenna;
a scanner;
a network interface connectable to an external device; and
a processor configured to
cause the antenna to wirelessly read code information for uniquely identifying an item from a wireless tag,
cause the scanner to read code information for uniquely identifying an item from a code symbol,
compare the code information read by the antenna with the code information read by the scanner, and
cause the network interface to transmit to the external device one or both of the code information read by the antenna and the code information read by the scanner based on a comparison result of the code information read by the antenna with the code information read by the scanner.

2. The item information reading apparatus according to claim 1, wherein
the processor is configured to determine a reading start timing of the antenna and a reading start timing of the scanner.

3. The item information reading apparatus according to claim 2, wherein
the processor is configured to
determine whether to cause the scanner to read the code information at the reading start timing of the antenna, or
determine whether to cause the antenna to read the code information at the reading start timing of the scanner.

4. The item information reading apparatus according to claim 1, wherein
the processor is configured to specify a format of information to be read by the scanner.

5. The item information reading apparatus according to claim 1, further comprising:
a trigger switch, wherein
the processor is configured to cause the antenna to start reading the code information and cause the scanner to start reading the code information when the trigger switch is pressed.

6. The item information reading apparatus according to claim 1, further comprising:
a trigger switch, wherein
the processor is configured to
cause a display device to display a menu for selecting one of an option in which the scanner is caused to start reading the code information when the trigger switch is pressed while the code information is being read by the antenna and an option in which the antenna is caused to start reading the code information when the trigger switch is pressed while the code information is being read by the scanner, and control the antenna and the scanner based on the selected one of the options.

7. The item information reading apparatus according to claim 1, further comprising:
a transmission buffer in which information is registered before being transmitted to the external device via the network interface, wherein
the processor is configured to
register the code information reading result in the transmission buffer when the code information read by the antenna and the code information read by the scanner are different, and
not register the code information reading result in the transmission buffer when the code information read by the antenna and the code information read by the scanner are identical.

8. A method performed by an item information reading apparatus, the method comprising:
causing an antenna of the item information reading apparatus to wirelessly read code information for uniquely identifying an item from a wireless tag;
causing a scanner of the item information reading apparatus to read code information for uniquely identifying an item from a code symbol;
comparing the code information read by the antenna with the code information read by the scanner; and
transmitting, to an external device connected to the item information reading apparatus, one or both of the code information read by the antenna and the code information read by the scanner based on a comparison result of the code information read by the antenna with the code information read by the scanner.

9. The method according to claim 8, further comprising:
determining a reading start timing of the antenna and a reading start timing of the scanner.

10. The method according to claim 9, further comprising:
determining whether to cause the scanner to read the code information at the reading start timing of the antenna, or
determining whether to cause the antenna to read the code information at the reading start timing of the scanner.

11. The method according to claim 8, further comprising:
specifying a format of information to be read by the scanner.

12. The method according to claim 8, wherein
the antenna is caused to start reading the code information and the scanner is caused to start reading the code information when a trigger switch of the item information reading apparatus is pressed.

13. The method according to claim 8, further comprising:
displaying a menu for selecting one of an option in which the scanner is caused to start reading the code information when a trigger switch of the item information reading apparatus is pressed while the code information is being read by the antenna and an option in which the antenna is caused to start reading the code information when the trigger switch is pressed while the code information is being read by the scanner; and
controlling the antenna and the scanner based on the selected one of the options.

14. The method according to claim 8, further comprising:
registering the code information reading result in a transmission buffer of the item information reading apparatus when the code information read by the antenna and the code information read by the scanner are different; and
not registering the code information reading result in the transmission buffer when the code information read by the antenna and the code information read by the scanner are identical.

15. A non-transitory computer-readable storage medium for causing a computer to execute a process comprising:
causing an antenna of the item information reading apparatus to wirelessly read code information for uniquely identifying an item from a wireless tag;
causing a scanner of the item information reading apparatus to read code information for uniquely identifying an item from a code symbol;
comparing the code information read by the antenna with the code information read by the scanner; and
transmitting, to an external device connected to the computer, one or both of the code information read by the antenna and the code information read by the scanner based on a comparison result of the code information read by the antenna with the code information read by the scanner.

16. The non-transitory computer-readable storage medium according to claim 15, wherein the process further comprises:
determining a reading start timing of the antenna and a reading start timing of the scanner.

17. The non-transitory computer-readable storage medium according to claim 16, wherein the process further comprises:
determining whether to cause the scanner to read the code information at the reading start timing of the antenna, or determining whether to cause the antenna to read the code information at the reading start timing of the scanner.

18. The non-transitory computer-readable storage medium according to claim 15, wherein
the antenna is caused to start reading the code information and the scanner is caused to start reading the code information when a trigger switch of the item information reading apparatus is pressed.

19. The non-transitory computer-readable storage medium according to claim 15, wherein the process further includes
displaying a menu for selecting one of an option in which the scanner is caused to start reading the code information when a trigger switch of the item information reading apparatus is pressed while the code information is being read by the antenna and an option in which the antenna is caused to start reading the code information when the trigger switch is pressed while the code information is being read by the scanner; and
controlling the antenna and the scanner based on the selected one of the options.

20. The non-transitory computer-readable storage medium according to claim 15, wherein the process further includes
registering the code information reading result in a transmission buffer of the item information reading apparatus when the code information read by the antenna and the code information read by the scanner are different; and
not registering the code information reading result in the transmission buffer when the code information read by the antenna and the code information read by the scanner are identical.
